(19) United States
(12) Patent Application Publication
(10) Pub. No.: US 2008/0091921 A1
(43) Pub. Date: Apr. 17, 2008

(54) DATA PREFETCHING IN A MICROPROCESSING ENVIRONMENT

(76) Inventors: Diab Abuaiadh, Haifa (IL); Daniel Citron, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/548,711

(22) Filed: Oct. 12, 2006

(51) Int. Cl. G06F 9/30

(52) U.S. Cl. 712/207

(57) ABSTRACT

Systems and methods for prefetching data in a microprocessor environment are provided. The method comprises decoding a first instruction; determining if the first instruction comprises both a load instruction and embedded prefetch data; processing the load instruction; and processing the prefetch data, in response to determining that the first instruction comprises the prefetch data, wherein processing the prefetch data comprises determining a prefetch multiple, a prefetch address and the number of elements to prefetch, based on the prefetch data.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to prefetching data in a microprocessing environment and, more particularly, to a system and method for decoding instructions comprising imbedded prefetch data.

### BACKGROUND

Modem microprocessors include cache memory. The cache memory (“cache”) stores a subset of data stored in other memories (e.g., main memory) of a computer system. Due to the cache's physical architecture and closer association with the microprocessor, accessing data stored in cache is faster in comparison with the main memory. Therefore, the instructions and data that are stored in the cache can be processed at a higher speed.

To take advantage of this higher speed, information such as instructions and data are transferred from the main memory to the cache in advance of the execution of a routine that needs the information. The more sequential the nature of the instructions and the more sequential the requirements for data access, the greater is the chance for the next required item to be found in the cache, thereby resulting in better performance.

In a computing system, different cache levels may be implemented. A level 1 (L1) cache is a memory bank built into the microprocessor chip (i.e., on chip). A level 2 cache (L2) is a secondary staging area that feeds the L1 cache and may be implemented on or off chip. Other cache levels (L3, L4, etc.) may be also implemented on or off chip, depending on the cache's hierarchical architecture.

In general, when a microprocessor (also referred to as a microcontroller, or simply as a processor) executes, for example, a load instruction, the processor first checks to see if the related data is present in the cache, searching through the cache hierarchy. If the data is found in the cache, the instruction can be executed immediately as the data is already present in the cache. Otherwise, the instruction execution is halted while the data is being fetched from higher cache or memory levels.

The fetching of the data from higher levels may take a relatively long time. Unfortunately, in some cases the wait time is an order of magnitude longer than the time needed for the microprocessor to execute the instruction. As a result, while the processor is ready to execute another instruction, the processor will have to sit idle waiting for the related data for the current instruction to be fetched into the processor.

The above problem contributes to reduced system performance. To remedy the problem, it is extremely beneficial to prefetch the necessary pieces of data into the lower cache levels of the processor in advance. Accordingly, most modem processors have added to or included in their instruction sets prefetch instructions to fetch a cache line before the data is needed.

A cache line is the smallest unit of data that can be transferred between the cache and other memories. In many software applications, programmers know they will be manipulating a large linear chunk of data (i.e., many cache lines). Consequently, programmers insert prefetch instructions into their programs to prefetch a cache line.

A programmer (or compiler) can insert a prefetch instruction to fetch a cache line, multiple instructions ahead of the actual instructions that will perform the arithmetic or logical operations on the particular cache line. Hence, a program may have many prefetch instructions sprinkled into it. Regrettably, these added prefetch instructions increase the size of the program code as well as the number of instructions that must be executed, resulting in code bloat.

Furthermore, under the conventional method, not only does the programmer have to sprinkle prefetch instructions into the code, but he also has to try to place them in the code so as to optimize their execution. That is, the programmer has to try to determine the timing of the execution of the prefetch instructions so that the data is in the cache when it is needed for execution (i.e., neither too early, nor too late).

In particular, the programmer has to place the prefetch instructions in the code such that the execution of one instruction does not hinder the execution of another instruction. For example, arrival of two prefetch instructions in close proximity may result in one of them being treated as a no-op and not executed.

Furthermore, to properly utilize a prefetch instruction, the programmer must know the cache line size for the particular processor architecture for which the program code is written. Thus, if the program code is to be executed on a processor with a compatible machine but a different microarchitecture the prefetching may not be correctly performed.

To avoid some of the problems associated with the above software prefetching schemes, certain processors have built in hardware prefetching mechanisms for automatically detecting a pattern during execution and fetching the necessary data in advance. In this manner, the processor does not have to rely on the compiler or the programmer to insert the prefetch instructions.

Unfortunately, there are several drawbacks also associated with hardware prefetching. For example, it may take several iterations for the hardware mechanism to detect that a prefetch is required, or that prefetching is no longer necessary. Further, hardware prefetching is generally limited to cache line chunks and doesn't take into consideration the requirements of the software.

Even further, the space used for implementing the prefetching hardware into the processor chip can be used for cache memory or other processor functionality. Since implementing complex schemes in silicon may significantly increase the time-to-market, any relative performance improvements that can be attributed to faster hardware prefetching may not be worthwhile.

Systems and methods are needed that can solve the above-mentioned shortcomings.

### SUMMARY

The present disclosure is directed to a system and corresponding methods that facilitate prefetching data in a microprocessor environment.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one aspect of the invention, a prefetching method comprises decoding a first instruction; determining if the first instruction comprises both a load instruction and prefetch data; processing the load instruction; and processing the prefetch data, in response to determining that the first instruction comprises the prefetch data.

In accordance with another aspect of the invention, a system for prefetching data in a microprocessor environment is provided. The system comprises a logic unit for decoding a first instruction; a logic unit for determining if the first instruction comprises both a load instruction and prefetch data; a logic unit for processing the load instruction; and a logic unit for processing the prefetch data, in response to determining that the first instruction comprises the prefetch data.

In accordance with yet another aspect, a computer program product comprising a computer useable medium having a computer readable program is provided, wherein the computer readable program when executed on a computer causes the computer to decode a first instruction; determine if the first instruction comprises both a load instruction and prefetch data; process the load instruction; and process the prefetch data, in response to determining that the first instruction comprises the prefetch data.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIGS. 1A through 1C illustrates exemplary instruction formats utilized in one or more embodiments of the invention to load or prefetch instructions or data.

FIG. 2 illustrates another exemplary instruction format, in accordance with one embodiment, for loading an instruction that includes prefetch data.

FIG. 3 is a flow diagram of an exemplary method for loading and prefetching instructions and data in accordance with a preferred embodiment.

FIGS. 4A and 4B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF PREFERRED EMBODIMENTS

The present disclosure is directed to systems and corresponding methods that facilitate data prefetching in a microprocessing environment.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

In accordance with one aspect of the invention, a microprocessing environment is defined by a set of registers, a timing and control structure, and memory that comprises different cache levels. A set of instructions can be executed in the microprocessing environment. Each instruction is a binary code, for example, that specifies a sequence of microoperations performed by a processor.

Instructions, along with data, are stored in memory. The combination of instructions and data is referred to as instruction code. To execute the instruction code, the processor reads the instruction code from memory and places it into a control register. The processor then interprets the binary code of the instruction and proceeds to execute it by issuing a sequence of microoperations.

An instruction codes is divided into parts, with each part having its own interpretation. For example, as provided in more detail below, certain instruction codes contain three parts: an operation code part, a source data part, and a destination data part. The operation code (i.e., opcode) portion of an instruction code specifies the instruction to be performed (e.g., load, add, subtract, shift, etc.). The source data part of the instruction code specifies a location in memory or a register to find the operands (i.e., data) needed to perform the instruction. The destination data part of an instruction code specifies a location in memory or a register to store the results of the instruction.

In an exemplary embodiment, the microprocessing environment is implemented using, a processor register (i.e., accumulator (AC)) and a multi-part instruction code (opcode, address). Depending upon the opcode used, the address part of the instruction code may contain either an operand (immediate value), a direct address (address of operand in memory), or an indirect address (address of a memory location that contains the actual address of the operand). The effective address (EA) is the address of the operand in memory.

The instruction cycle, in one embodiment, comprises several phases which are continuously repeated. In the initial phase an instruction is fetched from memory. The processor decodes the fetched instruction. If the instruction has an indirect address, the effective address for the instruction is read from memory. In the final phase, the instruction is executed.

In the following, one or more embodiments of the invention are disclosed, by way of example, as directed to PowerPC instruction set architecture (ISA) typical to most reduced instruction set computer (RISC) processors. It should be noted, however, that alternative embodiments may be implemented using any other instruction set architecture.

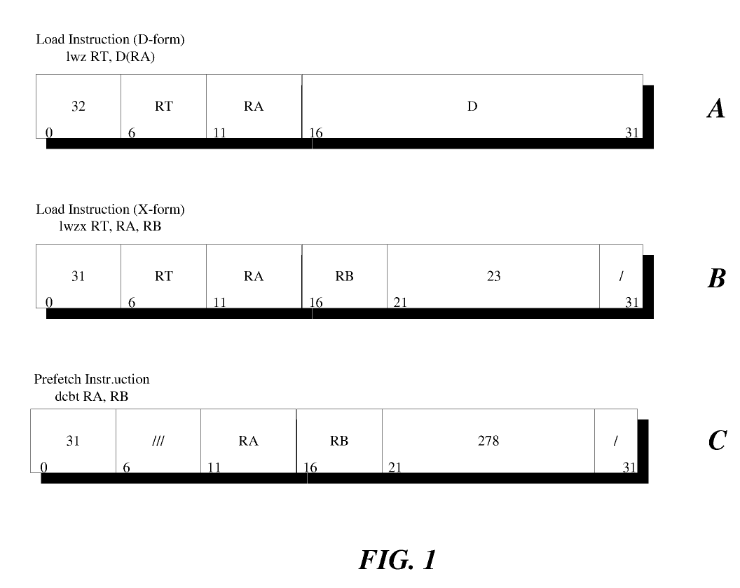

FIGS. 1A and 1B illustrate exemplary load instructions, in accordance with one embodiment. The former illustrates a D-form instruction (opcode, register, register, 16-bit immediate value) and the latter illustrates an X-form instruction (opcode, register, register, register, extended opcode). Each of the above formats has an update mode where the base register is updated with the current EA.

A D-form load instruction can be represented by lwz_RT,_D(RA) which when executed causes the processor to load a word from the effective address RA+D, computed by adding the value in register RA to the offset D and storing the word into the register RT.

An X-form load instruction can be represented by lwzx_RT,RA,RB which when executed causes the processor to load a word from the effective address RA +RB, computed by adding the value in register RA to the offset in register RB and storing the word into the register RT.

Referring to FIG. 1C, a prefetch instruction, in accordance with one embodiment, is implemented as an X-form instruction (opcode, empty field, register, register, extended opcode). An exemplary X-form prefetch instruction may be represented by dcbt_RA,RB which when executed causes the processor to prefetch the cache line that includes the effective address RA+RB.

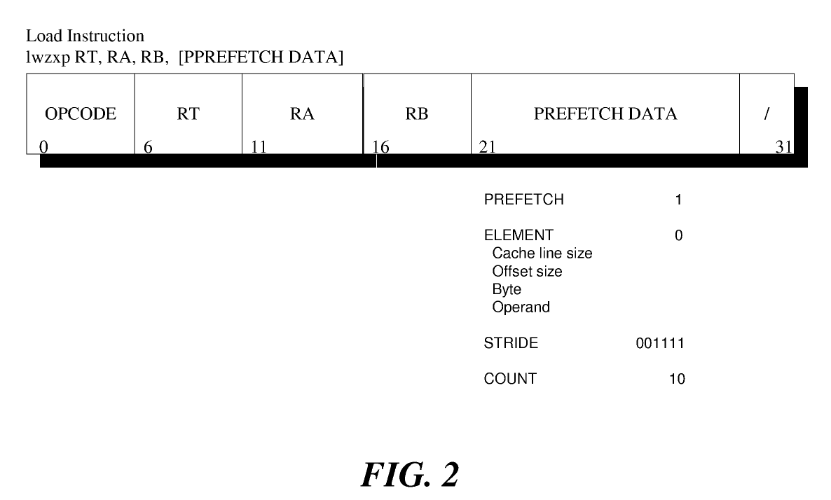

Each of the above instructions causes the processor to perform a microoperation. Referring to FIG. 2, in accordance with a preferred embodiment, some instructions are implemented to cause the processor to perform more than one microoperation. Hence, an opcode can be thought of as a macrooperation that specifies a set of microoperations to be performed.

As shown in FIG. 2, an exemplary load instruction as an X-form instruction is provided. Preferably, part of the extended opcode comprises prefetch data. In one embodiment, a load instruction (e.g., represented by “lwzx”) has a suffix (e.g., “p”) to indicate that load instruction includes prefetch data, for example. Thus, an exemplary X-form load instruction may be represented by lwzxp_RT,RA,RB[Prefetch_Data].

Preferably, the above load instruction when executed causes the processor to (1) load a word from the effective address RA+RB (i.e., add the value in register RA to the offset in register RB and store the word into the register RT), and (2) if indicated, prefetch a cache line in accordance with prefetch data embedded in the load instruction.

In accordance with one embodiment, the prefetch data uses the current EA as a base for future prefetch operations. In an exemplary embodiment, the prefetch data comprises one or more bits (i.e., prefetch bits) that comprise the following: prefetch indicator, prefetch element, prefetch stride, and prefetch count.

The prefetch indicator (e.g., one bit) indicates whether or not a prefetch instruction is embedded in the load instruction. For example, the value of “1” would indicate that prefetch data is included in the extended opcode (e.g., bits 21-30), and a value of “0” would indicate otherwise. In an alternative embodiment, the prefetch indicator field can be eliminated by using a special opcode (e.g., lwzxa) that indicates that the load instruction always includes prefetch data.

Referring back to FIG. 2, the prefetch element provides the prefetch multiple. The prefect multiple, depending on implementation, can define one or more of the following for a prefetching operation: cache line size, offset size, number of bytes, and the operand.

The cache line size defines the size of the cache line that is to be prefetched and is an implementation of the processor's micro-architecture. The offset size defines the size of the offset (i.e., index value) in the instruction and preferably is a multiple of the stride being used to read the data items.

The number of bytes defines the absolute number of bytes to be prefetched. This option provides some flexibility, as the programmer is not limited to choosing a fixed cache line size, or offset. The operand defines the size of the data that is being loaded from memory and can be defined as one or more bytes, half-words, words, double-words, or quad-words, for example.

The element field is preferably two bits long to implement some or all of the aforementioned options. In certain embodiments, a single bit can be used for the element field. However, a smaller number of options will be then available for that field.

The stride field is a signed value that is multiplied by the element field to produce a byte value that is added to the EA to produce the prefetch address (PA). A larger field yields more prefetch flexibility. For example if the element is a cache line of 128 bytes and the stride is −3 then the value −384 will be added to the EA, and a line will be fetched from there.

The count field indicates the total number of elements that are to be prefetched. For example, a value of zero can mean a single element is to be prefetch, a value of one can represent that two elements are to be prefetched, etc. In an exemplary embodiment, where a single element is to be prefetched each time, this field can be eliminated.

The number of bits used to represent the prefetch data can vary depending on implementation and particularly depending on the number of spare bits available in the extended opcode section (e.g., bits 21 to 30) of the load instruction. In the following, several examples are provided to enable a person of ordinary skill in the art to implement a load instruction word in accordance with one aspect of the invention. We should emphasize, however, that the following is provided for the purpose of example only and the scope of the invention should not be limited to these particular exemplary embodiments.

### EXAMPLE 1

Consider a load instruction having a 6-bit prefetch data comprising: 1 prefetch bit, 1 element bit (cache line or offset), and 4 stride bits. Accordingly, the encoding to prefetch the before last cache line can be represented by prefetch bits 101110, wherein the first bit (e.g., 1) indicates that the load instruction has prefetch data embedded in it. The second bit (e.g., 0) defines the prefetch element. In this example the value zero suggests a single element is to be prefetched. The least four significant bits (e.g., 1110) represent the prefetch stride, which defines the sequence of cache line references for each prefetch instruction.

### EXAMPLE 2

Consider a load instruction having a 10-bit prefetch data comprising: 1 prefetch bit, 1 element bit (cache line or bytes), 6 stride bits, 2 count bits. Referring to FIG. 2, the encoding to prefetch three cache lines starting from the next 15th line can be represented by 1000111110, wherein the first bit (e.g., 1) indicates that the load instruction has prefetch data embedded in it. The second bit (e.g., 0) defines the prefetch element, the value zero suggesting a single element is to be prefetched. The next 6 bits (e.g., 001111) represent the prefetch stride (e.g., 15^{th} line), and the least two significant bits (e.g., 10) represent the count indicating that, for example, three elements are to be prefetched.

### EXAMPLE 3

Consider a load instruction having 3-bits (e.g., 011) that provides for prefetching in strides of cache lines stride bits, 3 count bits. Thus, the encoding to prefetch the third cache line from the current line can be represented as 011.

To illustrate the advantage of embedding a prefetch instruction into a load instruction, consider an instruction sequence that adds two arrays of integers, as represented by the following algorithm:

for (i=0;i<N;i++)

c[i]=a[i]+b[i];

In an exemplary assembly code (e.g., PowerPC), the above algorithm can be written in the following form:
_L6c:
   lwzx r6,r3,r4 # load a[i]
   lwzu r7,4(r3) # load b[i]
   stwu r0,8(r5) # store c[i−1]
   add r6,r6,r7 # a[i]+b[i]
   lwzx r0,r3,r4 # load a[i+1]
   lwzu r7,4(r3) # load b[i+1]
   add r0,r0,r7 # a[i+1]+b[i+1]
   stw r6,4(r5) # store a[i]
   be BO_dCTR_NZERO,CR0_LT,_L6c # loop back

Since the algorithm requires consecutive load and store instructions of a specific item, the processor can speed up the execution of the algorithm by prefetching certain data (e.g., values for the array items) needed in advance. A software prefetch instruction added to the code would look like this:
_L6c:
   dcbt r3,r1 # prefetch from r3+r1
   addi r1,r1,128 # update r1
   lwzx r6,r3,r4 # load a[i]
   lwzu r7,4(r3) #load b[i]

As shown above, the prefetch instruction (e.g., debt) takes additional issue slots and uses additional registers. It also has to compute the EA an additional time.

In accordance with one aspect of the invention, following load instruction with an embedded prefetch data (e.g., 6 prefetch bits as shown in Example 1 above) can be used to reduce the number of lines of code used to perform the same operation:
_L6c:
   lwzxp r6,r3,r4,100001 # load a[i]
   lwzu r7,4(r3) # load b[i]

As such, in comparison with the earlier code sections, embedding the prefetch data in the load instruction requires the processor to fetch, decode and execute a smaller number of instructions and utilize fewer registers, by adding a few bits to the already computed EA. Advantageously, this prefetching scheme reduces code bloating common to most conventional software prefetching schemes and does not have the problems associated with hardware prefetching schemes noted earlier.

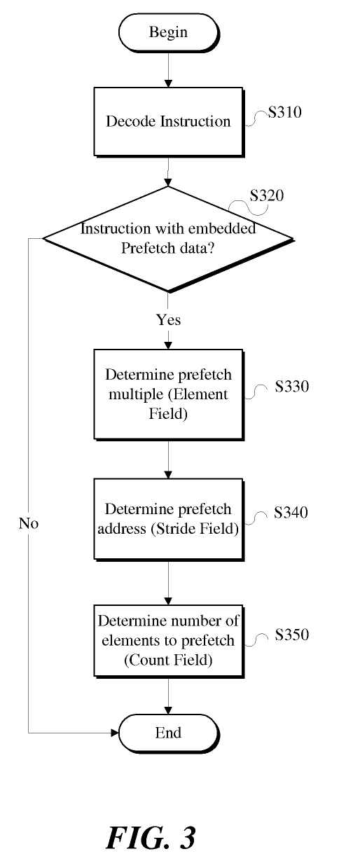

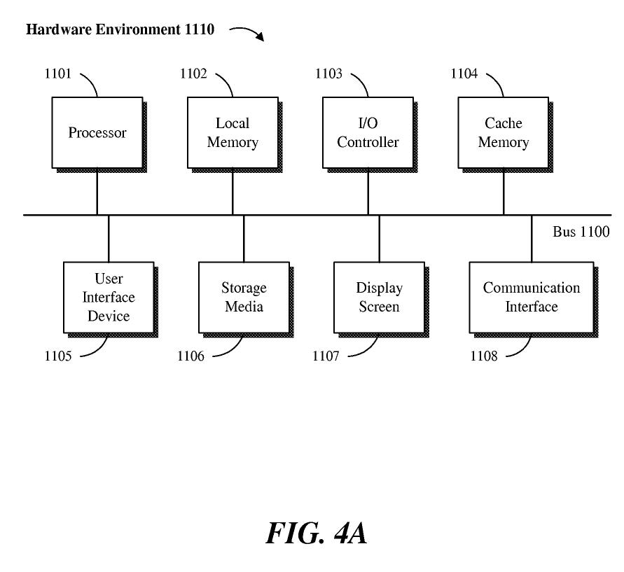

Referring to FIG. 3, in accordance with one embodiment, when the processor fetches an instruction, the instruction is loaded in a register (S310). The instruction is then decoded (S320) so that it can be determine if the instruction comprises embedded prefetch data (S330). If so, then the prefetch data is examined to determine the prefetch multiple (S330), prefetch address (S340) and the number of elements to be prefetch (S350) as disclosed in detail above.

One or more embodiments of the invention are disclosed herein, by way of example, as applicable to a load instruction having embedded prefetch data. It is noteworthy that the principal concepts and teachings of the invention can be equally applied to other types of instructions (e.g., store, add, etc.) or in CISC machines that may have a memory address as one of the operands, without detracting from the scope of the invention.

In different embodiments, the invention can be implemented either entirely in the form of hardware or entirely in the form of software, or a combination of both hardware and software elements. For example, the microprocessing environment disclosed above may comprise a controlled computing system environment that can be presented largely in terms of hardware components and software code executed to perform processes that achieve the results contemplated by the system of the present invention.

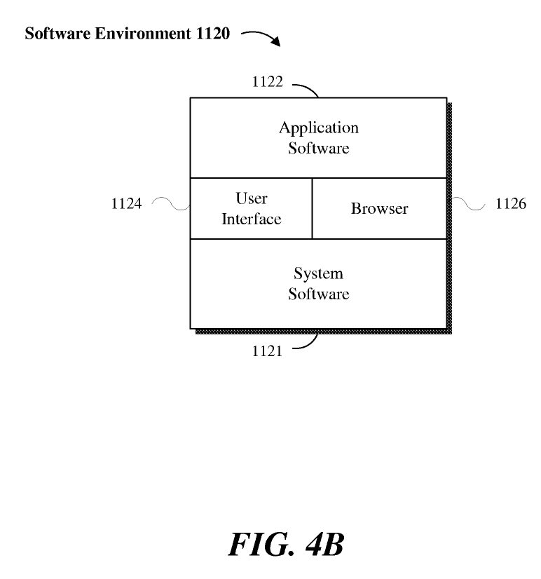

Referring to FIGS. 4A and 4B, a computing system environment in accordance with an exemplary embodiment is composed of a hardware environment 1110 and a software environment 1120. The hardware environment 1110 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 1120 is divided into two major classes comprising system software 1121 and application software 1122. System software 1121 comprises control programs, such as the operating system (OS) and information management systems that instruct the hardware how to function and process information.

In a preferred embodiment, compiler or other software is implemented as application software 1122 executed on one or more hardware environments to include prefetch instruction in executable code as provided earlier. Application software 1122 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital video disk (DVD).

Referring to FIG. 4A, an embodiment of the application software 1122 can be implemented as computer software in the form of computer readable code executed on a data processing system such as hardware environment 1110 that comprises a processor 1101 coupled to one or more memory elements by way of a system bus 1100. The memory elements, for example, can comprise local memory 1102, storage media 1106, and cache memory 1104. Processor 1101 loads executable code from storage media 1106 to local memory 1102. Cache memory 1104 provides temporary storage to reduce the number of times code is loaded from storage media 1106 for execution.

A user interface device 1105 (e.g., keyboard, pointing device, etc.) and a display screen 1107 can be coupled to the computing system either directly or through an intervening I/O controller 1103, for example. A communication interface unit 1108, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 1110 may not include all the above components, or may comprise other components for additional functionality or utility. For example, hardware environment 1110 can be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In some embodiments of the system, communication interface 1108 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 4B, application software 1122 can comprise one or more computer programs that are executed on top of system software 1121 after being loaded from storage media 1106 into local memory 1102. In a client-server architecture, application software 1122 may comprise client software and server software. For example, in one embodiment of the invention, client software is executed on computing system 100 and server software is executed on a server system (not shown).

Software environment 1120 may also comprise browser software 1126 for accessing data available over local or remote computing networks. Further, software environment 1120 may comprise a user interface 1124 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps can be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention and are further defined by the claims and their full scope of equivalents.

What is claimed is:

1. A method for prefetching data in a microprocessor environment, the method comprising:
decoding a first instruction;
determining if the first instruction comprises both a load instruction and prefetch data;
processing the load instruction; and
processing the prefetch data, in response to determining that the first instruction comprises the prefetch data.

2. The method of claim 1, wherein processing the prefetch data comprises determining a prefetch multiple, based on a first set of bits in the prefetch data.

3. The method of claim 1, wherein processing the prefetch data comprises determining a prefetch address, based on a second set of bits in the prefetch data.

4. The method of claim 1, wherein processing the prefetch data comprises determining number of elements to prefetch, based on a third set of bits in the prefetch data.

5. The method of claim 2, wherein the prefetch multiple comprises a prefetch element representing a cache line size for a prefetch operation.

6. The method of claim 2, wherein the prefetch multiple comprises a prefetch element representing an offset size for a prefetch operation.

7. The method of claim 2, wherein the prefetch multiple comprises a prefetch element representing number of bytes to be prefetched in a prefetch operation.

8. The method of claim 2, wherein the prefetch multiple comprises a prefetch element representing an operand for a prefetch operation.

9. The method of claim 2, wherein the prefetch multiple comprises at least one of a cache line size, an offset size, number of bytes to be prefetched, and an operand for a prefetch instruction.

10. The method of claim 1, wherein processing the prefetch data comprises:
determining a prefetch multiple, based on a first set of bits in the prefetch data;
determining a prefetch address, based on a second set of bits in the prefetch data; and
determining number of elements to prefetch, based on a third set of bits in the prefetch data.

11. A system for prefetching data in a microprocessor environment, the system comprising:
a logic unit for decoding a first instruction;
a logic unit for determining if the first instruction comprises both a load instruction and prefetch data;
a logic unit for processing the load instruction; and
a logic unit for processing the prefetch data, in response to determining that the first instruction comprises the prefetch data.

12. The system of claim 1 1, wherein processing the prefetch data comprises determining a prefetch multiple, based on a first set of bits in the prefetch data.

13. The system of claim 11, wherein processing the prefetch data comprises determining a prefetch address, based on a second set of bits in the prefetch data.

14. The system of claim 1 1, wherein processing the prefetch data comprises determining number of elements to prefetch, based on a third set of bits in the prefetch data.

15. The system of claim 12, wherein the prefetch multiple comprises at least one of a cache line size, an offset size, number of bytes to be prefetched, and an operand for a prefetch instruction.

16. A computer program product comprising a computer useable medium having a computer readable program, wherein the computer readable program when executed on a computer causes the computer to:
decode a first instruction;
determine if the first instruction comprises both a load instruction and embedded prefetch data;
process the load instruction; and
process the prefetch data, in response to determining that the first instruction comprises the prefetch data.

17. The computer program product of claim 1, wherein processing the prefetch data comprises determining a prefetch multiple, based on a first set of bits in the prefetch data.

18. The computer program product of claim 1, wherein processing the prefetch data comprises determining prefetch address, based on a second set of bits in the prefetch data.

19. The computer program product of claim 1, wherein processing the prefetch data comprises determining number of elements to prefetch, based on a third set of bits in the prefetch data.

20. The computer program product of claim 1, wherein the prefetch multiple comprises at least one of a cache line size, an offset size, number of byres to be prefetched, and an operand for a prefetch instruction.
